(19) United States
(12) Patent Application Publication
(10) Pub. No.: US 2021/0188707 A1
(43) Pub. Date: Jun. 24, 2021

(54) COPPER SLAG-FLY ASH GEOPOLYMER, A PREPARATION METHOD THEREOF, AND USE THEREOF

(71) Applicant: North Minzu University, Yinchuan (CN)

(72) Inventors: Fenglan HAN, Yinchuan (CN); Yangwei QU, Yinchuan (CN)

(21) Appl. No.: 16/927,034

(22) Filed: Jul. 13, 2020

(30) Foreign Application Priority Data
Dec. 24, 2019 (CN) 201911342073.8

(51) Int. Cl. C04B 28/00; C04B 22/06; C04B 40/02

(52) U.S. Cl. CPC C04B 28/006; C04B 2111/2084; C04B 40/0263; C04B 22/062

(57) ABSTRACT

The present invention discloses a copper slag-fly ash geopolymer, a preparation method thereof, and use thereof, belongs to the technical field of geopolymer. The preparation method of copper-fly ash geopolymer provided by the application comprises the steps of: mixing the copper slag, fly ash and alkali activator solution, obtaining a slurry; proceeding polymerization to the slurry, obtaining a copper slag-fly ash geopolymer. The fly ash and copper slag are used as raw materials in the application, which greatly improve the utilization rate of the industrial waste residue. The advantages line in that no need for additional addition of inorganic reinforcing filler, low production cost, simple operation and competency for industrial production. Moreover, the copper slag-fly ash geopolymer has good compressive strength, and can solidify the heavy metal ions in copper slag at the same time, thus reducing the environmental pollution.

### CROSS REFERENCE TO RELATED APPLICATION

This application claims the priority to Chinese Patent Application No. 201911342073.8, entitled “Copper slag-fly ash geopolymer, a preparation method thereof, and use thereof” filed on Dec. 24, 2019, which is incorporated herein by reference in its entirety.

### TECHNICAL FIELD

This application relates to the technical field of geopolymer, especially relating to a copper slag-fly ash geopolymer and a preparation method thereof.

### BACKGROUND ART

Fly ash is the main solid waste discharged from the coal-fired power plant. Its chemical composition is mainly SiO₂ and Al₂O₃, and it has the main mineral materials for preparing geopolymers. Fly ash geopolymer is a kind of aluminosilicate type zeolite materials that uses the fly ash as main raw material, and fully mixed with aluminum-containing clay (mainly metakaolin or kaolinite) and appropriate amount of alkali silicate solution, and thus forming and hardening under the condition of low temperature. The fly ash geopolymer has the properties of the material such as polymer, ceramic and cement, and can be used as cementitious material for the preparation of concrete, mortar and the like, with remarkable economic and environmental benefits.

Although fly ash has the main mineral components needed by the preparation of the geopolymer, due to the relatively low CaO content, the geopolymer using pure fly ash as raw material has relatively low strength. At present, in order to increase the strength of the fly ash geopolymer, additional addition of inorganic reinforcing filler to the preparation process is needed, for example, Chinese patent CN103214263A discloses a preparation method of foaming fly ash geopolymer exterior wall insulation board, by adding slag powder, and fine aggregates such as nano-calcium carbonate, grinding fine kaolin, silicon powder, and micro silicon powder to increase its strength, however, adding inorganic reinforcing filler reduces the utilization of fly ash, and increases the production cost.

### SUMMARY OF THE INVENTION

The purpose of the application is to provide a copper slag-fly ash geopolymer, a preparation method thereof and use thereof. The preparation method provided by the application uses copper slag and fly ash as raw materials with high utilization rate and low production cost, and the obtained copper slag-fly ash geopolymer has high compressive strength.

For the purpose of the application, the application provides the following technical schemes:

The application provides a preparation method of copper slag-fly ash geopolymer, including the following steps:
mixing the copper slag, fly ash and alkali activator solution, obtaining a slurry;
proceeding polymerization to the slurry, obtaining a copper slag-fly ash geopolymer.

Preferably, the copper slag comprises the following components with a mass percentage: CaO 3-10%, Al₂O₃ 3-7%, MgO 1-8%, Fe₂O₃ 5-16%, SiO₂ 32-45% and K₂O 2-4.5%.

Preferably, the fly ash comprises the following components with a mass percentage: CaO 0.3-12.8%, Al₂O₃ 17-27%, MgO 0.1-2.9%, Fe₂O₃ 5-13%, SiO₂ 45-55% and K₂O 1-3.6%.

Preferably, the mass of the copper slag is 10-40% of the total mass of the copper slag and fly ash.

Preferably, the alkali activator solution comprises alkali activator and water, the alkali activator comprises water glass and sodium hydroxide.

Preferably, the mass of the alkali activator in the solution is 20-35% of the total mass of the copper slag and fly ash.

Preferably, the modulus of the alkali activator is 0.4-1.2.

Preferably, the polymerization is performed under the condition of: temperature: 40-120° C., time: 4-24 h.

The application provides a copper slag-fly ash geopolymer prepared by the method mentioned in the above technical schemes, including a Si—O—Al three-dimensional net structure that the [SiO₄] tetrahedron and [AlO₄] tetrahedron are alternately bonded and polymerized through shared oxygen atoms, the chemical composition of the Si—O—Al three-dimensional net structure is Mₙ[(SiO₂)_{z}—AlO₂]ₙ.wH₂O, M is Na and/or K⁺, z [symbol] 1, w is 0-4.

The application provides the use of the copper slag-fly ash geopolymer mentioned in the technical schemes above, including the use in civil engineering, and as the matrix of quick repair material, high temperature resistance and fire-proof material, toxic waste solid sealing material, porous insulation material or composite functional material.

The application discloses a preparation method of copper slag-fly ash geopolymer, including the following steps: mixing the copper slag, fly ash and alkali activator solution, obtaining a slurry; proceeding polymerization to the slurry, obtaining a copper slag-fly ash geopolymer. The fly ash and copper slag are used as raw materials in the application, which greatly improve the utilization rate of the industrial waste residue; copper used as the coarse aggregate, may improve the strength of the geopolymer, and requires no additional inorganic reinforcing filler that reduce the production cost; the revolved operations are simple and suitable for industrial production.

Moreover, the copper slag-fly ash geopolymer has good compressive strength, and may solidify the heavy metal ions in copper slag at the same time, thus avoiding the secondary pollution to the environment by the copper slag-fly ash geopolymer.

### BRIEF DESCRIPTION OF THE DRAWINGS

FIG. 1 is a structure diagram of copper slag-fly ash geopolymer with different Si/Al ratios.

FIG. 2 is an XRD diffraction pattern of fly ash.

FIG. 3 is an XRD diffraction pattern of copper slag.

FIG. 4 is an infrared spectrum diagram of the structure diagram of copper slag-fly ash geopolymer prepared by example 1, wherein Cu represents copper slag, FA represents fly ash and FC represents copper slag-fly ash geopolymer.

FIG. 5 is a diagram of compressive strength of the copper slag-fly ash geopolymer in examples 1˜4 and comparative example 1.

FIG. 6 is a diagram of compressive strength of the copper slag-fly ash geopolymer in examples 5˜8 and comparative example 2.

FIG. 7 is a diagram of compressive strength of the copper slag-fly ash geopolymer in examples 9˜13.

FIG. 8 is a diagram of compressive strength of the copper slag-fly ash geopolymer in examples 14˜18.

### DETAILED DESCRIPTION OF THE EMBODIMENTS

The present application provides a preparation method of copper slag-fly ash geopolymer, including the following steps:
the copper slag, fly ash and alkali activator solution are mixed, a slurry is obtained;
a polymerization is proceeded to the slurry, a copper slag-fly ash geopolymer is obtained.

In the present application, unless otherwise specified, all of the raw materials are well known and commercial available to those skilled in the art.

In the application, the copper slag preferably comprises the following components with a mass percentage: CaO 3-10%, Al₂O₃ 3-7%, MgO 1-8%, Fe₂O₃ 5-16%, SiO₂ 32-45% and K₂O 2-4.5%; in an embodiment of the application, the copper slag preferably comprises the following components with a mass percentage: CaO 5.1%, Al₂O₃ 13.1%, MgO 7.4%, Fe₂O₃ 14.5%, SiO₂ 43.1% and TiO₂ 0.4%. In the application, the copper slag is preferably sourced from Inner Mongolia.

In the application, the fly ash preferably comprises the following components with a mass percentage: CaO 0.3-12.8%, Al₂O₃ 17-27%, MgO 0.1-2.9%, Fe₂O₃ 5-13%, SiO₂ 45-55% and K₂O 1-3.6%; in an embodiment of the application, the fly ash preferably comprises the following components with a mass percentage: CaO 4.8%, Al₂O₃ 18.2%, MgO 1.8%, Fe₂O₃ 5.9%, SiO₂ 48.5% and TiO₂ 0.6%. In the application, the fly ash is preferably sourced from Ningxia.

In the application, the mass of the copper slag is preferably 10-40% of the total mass of the copper slag and fly ash, more preferably 10-35%, further preferably 10-30%.

In the application, the alkali activator solution preferably comprises alkali activator and water, the alkali activator preferably comprises water glass and sodium hydroxide. In the application, the mass of the alkali activator in the solution is preferably 20-35% of the total mass of the copper slag and fly ash, more preferably 20-30%, further preferably 25-35%. The application has no special limit for the addition amount of the sodium hydroxide, any amount that can meet the modulus requirements of the alkali activator will do. In the application, the modulus of the alkali activator is preferably 0.4-1.2, more preferably 0.5-1.0, further preferably 0.6-0.8. In the application, the water mass is preferably 12-14% of the total mass of the copper slag and fly ash, more preferably 13%.

In the application, the alkali activator is preferably prepared when it is in need; preferably, the preparation method of the alkali activator solution is to dissolve sodium hydroxide in water, and mix the resulting sodium hydroxide solution with water glass to obtain the alkali activator solution.

In the application, the mixing sequence of the copper slag, fly ash and alkali activator solution is preferably to conduct a first mixing of the copper slag and fly ash to obtain a mixed slag charge; a slurry is obtained by a second mixing of the mixed slag charge and the alkali activator solution. In the application, the first mixing and second mixing is preferably stirring mixing, and the application has no special limit for the first mixing time, any time that can mix the copper slag and fly ash evenly will do; the second mixing time is preferably 150 s. In the application, during the mixing processes, the active SiO₂ and Al₂O₃ in the copper slag and fly ash are dissolved in the sodium hydroxide solution of the alkali activator solution, and at the same time, a small number of covalent bonds of silicon oxygen and aluminum oxygen in copper slag and fly ash will break, and thus Si and Al will become ions to exist in the system.

After obtaining the slurry, a polymerization is proceeded to the slurry in the application, and the copper slag-fly ash is obtained.

In the application, it is preferable to place the slurry into a mold, and then vibrates and seals the resulting mold containing the slurry before conducting polymerization reaction; In the application, the vibration is preferably carried out on a vibrating table; the shaking table is preferably a ZS-15 cement gel sand shaking table, and the vibration frequency of the shaking table is preferably 1 time per second; the vibration time is preferably 1 min; through the vibration, the bubbles in slurry can be removed, thus improving the compressive strength of copper slag-fly ash geopolymer. The application has no special limit for the sealing method, and adopts the sealing methods known in the field; In some embodiments of the invention, the sealing method is preferably covering of cling film; by sealing, it can be avoided that the compressive strength of copper slag-fly ash geopolymer decreases with excessive water loss of slurry during polymerization.

The application has no special limit for the equipment used for the polymerization reaction, equipment known in the field will do. In some embodiments of the application, the polymerization reaction is preferably carried out in an oven. In the present application, the polymerization reaction temperature is preferably 40-120° C., more preferably 80-120° C., and further preferably 80° C.; the reaction time is preferably 4-24 h, more preferably 8-16 h and further preferably 8-12 h. In the process of polymerization, the alumina-silica raw materials in copper slag and fly ash react with alkali activator solution to form the geopolymer precursor under the alkali condition, namely, the polymerized Si—O-al-O chain is formed, as shown in Equation (1); Subsequently, the geopolymer precursor reacts with sodium hydroxide to form the copper slag-fly ash geopolymer. At the same time, the excess water in the precursor of the geopolymer is gradually eliminated, and the precursor is consolidated and hardened into cross-linked copper slag-fly ash geopolymer. The reaction formula is shown in Equation (2);

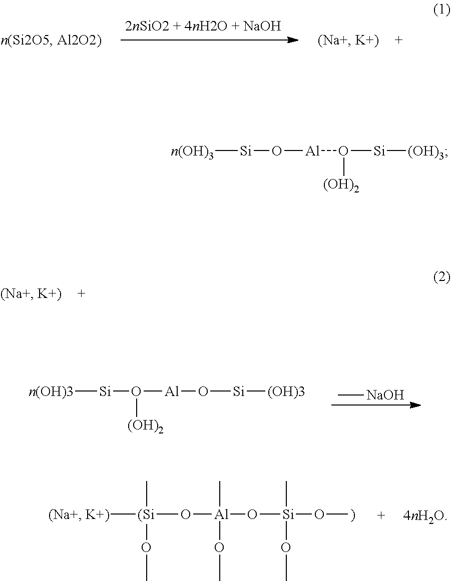

After the polymerization reaction is completed, the obtained geopolymer is preferably cured to curing age after demoulding, thus obtaining the copper slag-fly ash geopolymer. In the application, the curing age is preferably 3 days, 7 days or 28 days. The application has no special limit for the demoulding way, any way known in the field will do. In the application, the curing temperature is preferably 10-40° C., in some embodiments of the application, the curing temperature is preferably the room temperature.

The application uses fly ash and copper slag as raw materials, which greatly improve the utilization rate of industrial waste slag; there is no need to add inorganic reinforcing filler, achieving low production cost; the advantages line in the simplicity in operation and competency for industrial production.

The present application provides the copper slag-fly ash geopolymer prepared by the preparation method described in the above technical scheme, including a Si—O—Al three-dimensional net structure that the [SiO₄] tetrahedron and [AlO₄] tetrahedron are alternately bonded and polymerized through shared oxygen atoms, the chemical composition of the Si—O—Al three-dimensional net structure is Mₙ[(SiO₂)_{z}—AlO₂]ₙ.wH₂O, in which, M is Na and/or K⁺, z [symbol] 1, w is 0-4.

In the application, z is preferably 1-3. The present application has no special limit for the value of n, n [symbol] 1 will do. In addition, the copper slag-fly ash geopolymer provided by the present application also contains a small amount of solidified heavy metals, which improves the strength of the copper slag-fly ash geopolymer.

In the present application, the [SiO₄] tetrahedron is electrically neutral and the [AlO₄] tetrahedron is electronegative, and the combination with Na in alkali activator solution makes the copper slag-fly ash geopolymer electrically neutral.

In the present application, M is Na⁺ and/or K⁺, n represents polymerization degree, z is Si/Al ratio, w is the number of chemically combined water. As shown in FIG. 1, when z is respectively 1, 2, 3, and >3, four different copper slag-fly ash geopolymer monomers can be obtained, the monomer structure and three-dimensional amorphous network structure of the copper slag-fly ash geopolymer are shown in FIG. 1, when z=1, the copper slag-fly ash geopolymer is polysialate (PS); when z=2, the copper slag-fly ash geopolymer is polysialate-siloxo (PSS); when z=3, the copper slag-fly ash geopolymer is polysialate-disiloxo (PSDS); when z>3, the copper slag-fly ash geopolymer is polysialate.

The copper slag-fly ash geopolymer provided by the application uses copper slag as raw material and can solidify Cu²⁺, Pb²⁺, Cr³⁺ and Ni²⁺ heavy metal ions contained in copper slag, which reduces environmental pollution caused by industrial waste slag. The solidification mechanism of the copper slag-fly ash geopolymer is as follows:

(1) when the heavy metal ions in the copper slag reacts with the OH⁻ in the system and resulting with negative charged heavy metal hydroxyl complexing ions, which can proceed hydrogen bonding interaction with the surface Si—OH of the unreacted fly ash particles and be cured, the heavy metal hydroxyl complexing ions are mainly fixedly sealed in the copper slag-fly ash geopolymer by physical encapsulation.

(2) when the heavy metals in copper slag exist in the form of free cation in geopolymer, the free heavy metal cations can proceed ion exchange with Na⁻ and/or K⁺ in copper slag-fly ash geopolymer, and are used in balancing the negative charge of the [AlO₄] tetrahedron and fixed in the three-dimensional gel skeleton structure of copper slag-fly ash geopolymer.

(3) when the heavy metal ions in copper slag exist in the form of hydroxide precipitation on the surface of copper slag-fly ash geopolymer, the solidified body of copper slag-fly ash geopolymer and heavy metal hydroxide can be obtained; then the solidified body is put into the acidic solution, and then the heavy metal hydroxide precipitate is dissolved into a free cation and removed.

The application provides the use of the copper slag-fly ash geopolymer described in the above technical schemes: it can be used in civil engineering, and as the matrix of quick repair material, high temperature resistance and fire-proof material, toxic waste solid sealing material, porous insulation material, or composite functional material.

The copper slag-fly ash geopolymer prepared by the application uses copper slag and fly ash as raw materials, which have the advantages that is easy to obtain and cheap, pollution-free, and possess mechanical properties, durability, high temperature resistance and corrosion resistance and etc., and thus have a wide application prospect, and can be used in civil engineering as quick repair materials.

The copper slag-fly ash geopolymer prepared by the application has the properties of rapid hardening, high early strength and the like, which can be used in civil engineering, and significantly improve the mold rotation in construction;

The copper slag-fly ash geopolymer prepared by the application has low thermal conductivity and high mechanical properties in high temperature, which can be widely used in high-temperature resistant and fire-proof materials.

The copper slag-fly ash geopolymer prepared by the application has a unique three-dimensional network structure, which can be used for solid sealing treatment of heavy metals, harmful substances and nuclear waste.

The porous material prepared by using the copper slag-fly ash geopolymer as the matrix has the advantages of high strength, high porosity, high temperature and pressure resistance, good durability and regeneration ability.

In addition, the copper slag-fly ash geopolymer prepared by the application can also be used as the matrix of composite functional materials, with the addition of other additives, the composite materials, for example building materials such as permeable bricks and the like, with good performance is prepared.

The technical scheme of the application will be described clearly and completely in combination with the embodiments in the application. Obviously, the embodiments described are only part of the embodiments of the application, not all of them. Based on the embodiments in the application, all other embodiments obtained by ordinary technicians in the field without creative labor shall be covered by the protection of the application.

### Example 1

Sodium hydroxide was mixed with water, water glass was added to mix evenly, and then an alkali activator solution was obtained;
copper slag and fly ash were mixed evenly, a mixed slag was obtained;
the mixed slag and the alkali activator solution were mixed for 150 s, and a slurry was obtained;

The slurry was placed in a mold, and then, in sequence, placed on a shaking table for 1 min, sealed with fresh-keeping film, placed in an 80° C. oven and polymerized for 12 h, cured to curing age at room temperature, and a copper slag-fly ash geopolymer was obtained.

Based on the mass of the mixed slag, the mass of the copper slag was 10 wt %, the mass of the alkali activator was 25 wt %, the mass of the water was 13 wt %, and the modulus of the alkali activator was 1.2.

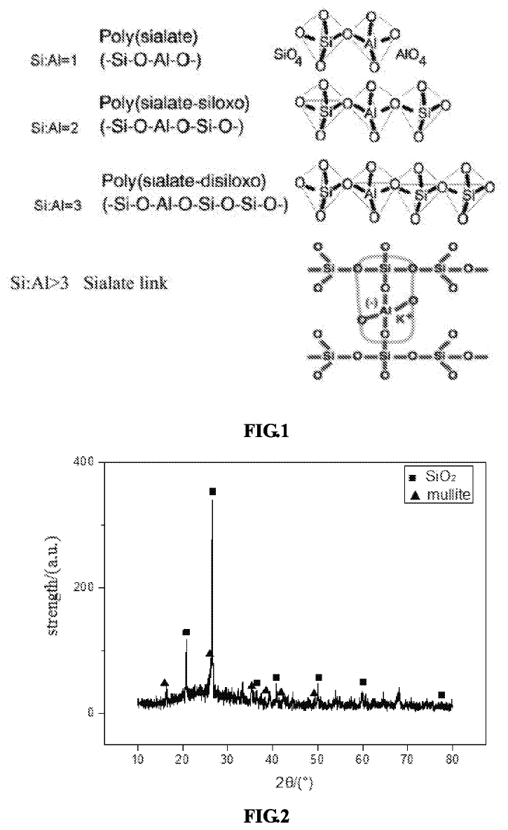

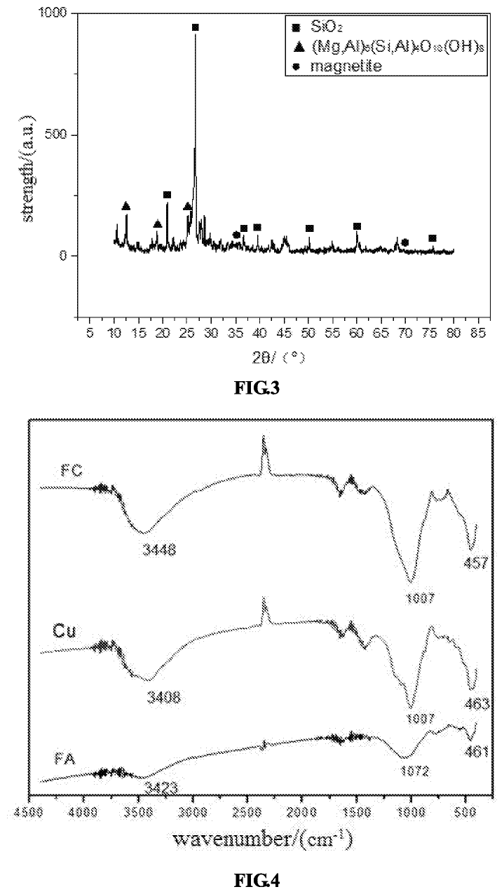

The XRD diffraction pattern of fly ash was shown in FIG. 2, and the XRD diffraction pattern of copper slag was shown in FIG. 3.

The infrared spectrum of copper slag (Cu), fly ash (FA) and copper slag-fly ash geopolymer (FC) prepared in this embodiment were shown in FIG. 4. It can be seen from FIG. 4 that the absorption peak near 461 cm⁻¹ is corresponded to the symmetric stretching vibration and bending vibration of Al—O—Si bond and Si—O bond, and the copper slag-fly ash geopolymer reaction has little influence on this part of the absorption peak; the peak between 1000-1200 cm⁻¹ is an asymmetric stretching vibration band of Si—O—Si and Si—O—Al, compared to the fly ash, the stretching vibration peaks of Si—O—Si and Si—O—Al in the copper slag-fly ash geopolymer move in the direction of low wave number, which indicates that, in the polymerization reaction, AlO₄ replaces part of SiO₄ group in Si—O—Si chain structure in raw materials, resulting with changes of the SiO₄ surrounding environment, thus affecting the internal structure of the system and the Si—O stretching vibration band with a certain migration. It is indicated that the glassy coating composition is reacted with alkali to form a new aluminosilicate gel; the peak between 3000-4000 cm⁻¹ indicates the existence of —OH, this is because a small amount of water still exists in the raw material of alkali activator or copper slag, fly ash.

### Examples 2˜20

Geopolymer of copper slag-fly ash was prepared according to the method of Example 1. The preparation conditions of examples 2˜20 were shown in Table 1.

The compressive strength of copper slag-fly ash geopolymer was determined according to GB/T 17671-1999, and the 28 d compressive strength was shown in Table 1.

TABLE 1
preparation conditions and 28 d geopolymer compressive strength of
examples 1-20

| | | water glass | | | | 28 d |
|---|---|---|---|---|---|---|
| | copper | and sodium | | | | compressive |
| | slag/ | hydroate/ | water/ | modu- | curing | strength/ |
| example | wt % | wt % | wt % | lus | time/h | MPa |
| example 1 | 10 | 25 | 13 | 1.2 | 12 | 30.89 |
| example 2 | 20 | 25 | 13 | 1.2 | 12 | 32.49 |
| example 3 | 30 | 25 | 13 | 1.2 | 12 | 28.97 |
| example 4 | 40 | 25 | 13 | 1.2 | 12 | 21.37 |
| comparative | 50 | 25 | 13 | 1.2 | 12 | 17.25 |
| example 1 | | | | | | |
| comparative | 20 | 15 | 13 | 1.2 | 12 | 14.48 |
| example 2 | | | | | | |
| example 5 | 20 | 20 | 13 | 1.2 | 12 | 20.10 |
| example 6 | 20 | 25 | 13 | 1.2 | 12 | 32.49 |
| example 7 | 20 | 30 | 13 | 1.2 | 12 | 33.09 |
| example 8 | 20 | 35 | 13 | 1.2 | 12 | 30.65 |
| example 9 | 20 | 25 | 13 | 0.4 | 12 | 46.76 |
| example 10 | 20 | 25 | 13 | 0.6 | 12 | 47.53 |
| example 11 | 20 | 25 | 13 | 0.8 | 12 | 38.15 |
| example 12 | 20 | 25 | 13 | 1.0 | 12 | 34.10 |
| example 13 | 20 | 25 | 13 | 1.2 | 12 | 32.49 |
| example 14 | 20 | 25 | 13 | 1.2 | 4 | 22.93 |
| example 15 | 20 | 25 | 13 | 1.2 | 8 | 29.61 |
| example 16 | 20 | 25 | 13 | 1.2 | 12 | 32.49 |
| example 17 | 20 | 25 | 13 | 1.2 | 16 | 33.67 |
| example 18 | 20 | 25 | 13 | 1.2 | 24 | 37.49 |

The 3 d, 7 d and 28 d compressive strength of the copper slag-fly ash geopolymer prepared from examples 1˜18 and comparative examples 1˜2 were measured according to the standard GB/T 17671-1999. The results were shown in FIGS. 5˜8.

FIG. 5 shows the compressive strength of the copper slag-fly ash geopolymer prepared by examples 1˜4 and comparative example 1, that is the result of influence of the copper slag addition on the compressive strength of copper slag-fly ash geopolymer. As can be seen from FIG. 5, with the increase of copper slag addition, the compressive strength of the copper slag-fly ash geopolymer at 3 d, 7 d and 28 d increases first and then decreases, and the optimum amount of copper slag addition is 20 wt %.

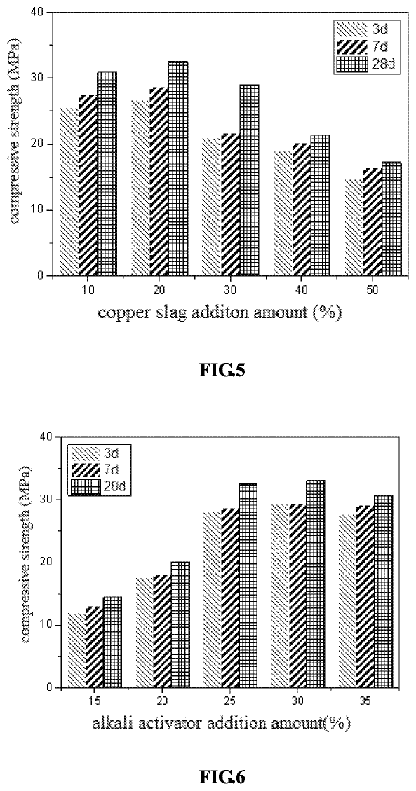

FIG. 6 shows the compressive strength of the copper slag-fly ash geopolymer prepared by examples 5˜8 and comparative example 2, that is the result of influence of the alkali activator addition on the compressive strength of copper slag-fly ash geopolymer. As can be seen from FIG. 6, with the increase of alkali activator addition, the compressive strength of the copper slag-fly ash geopolymer at 3 d, 7 d and 28 d also increases, and the optimum amount of alkali activator addition is 25 wt %.

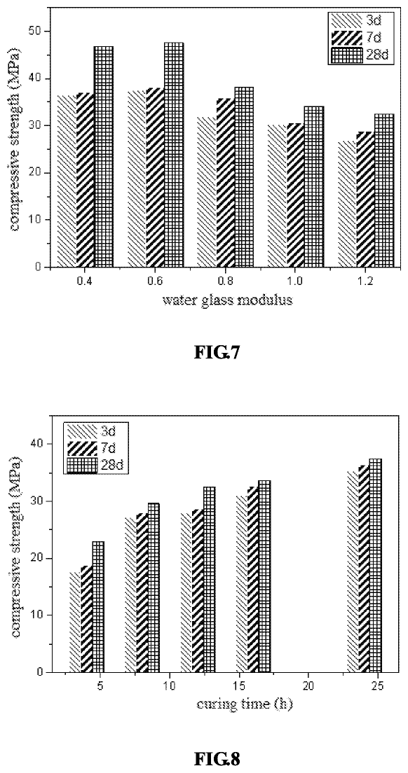

FIG. 7 shows the compressive strength of the copper slag-fly ash geopolymer prepared by examples 9˜13, that is the result of influence of the alkali activator modulus on the compressive strength of copper slag-fly ash geopolymer. As can be seen from FIG. 7, with the increase of alkali activator modulus, the compressive strength of the copper slag-fly ash geopolymer at 3 d, 7 d and 28 d increases slightly and then decreases, when the modulus is 0.6, the compressive strength is the highest, but when the modulus is 1.2, the samples of autoclaved aerated concrete block accorded with GB 11968-2006 can also be prepared, so that in view of the economy, the optimum modulus of alkali activator is 1.2.

FIG. 8 shows the compressive strength of the copper slag-fly ash geopolymer prepared by examples 14˜18, that is the result of influence of the curing time on the compressive strength of copper slag-fly ash geopolymer. As can be seen from FIG. 8, with the increase of curing time, the compressive strength of the copper slag-fly ash geopolymer at 3 d, 7 d and 28 d also increases, after the curing time exceeds 12 h, the compressive strength of copper slag-fly ash geopolymer changes little, so that in view of the economy and energy saving, the optimum curing time is 12 h.

In conclusion, the present application uses copper slag and fly ash as raw materials, under the effect of alkali activator solution, the copper slag-fly ash geopolymer has good compressive strength.

The above described are only preferred embodiments of the present application. It should be understood by those skilled in the art that, without departing from the principle of the present application, any variations and modifications fall into the scope of the present application.

What is claimed is:

1. A method for preparing a copper slag-fly ash geopolymer, the method comprising:
mixing the copper slag, the fly ash, and an alkali activator solution, thereby obtaining a slurry; and
proceeding polymerization to the slurry, obtaining a copper slag-fly ash geopolymer.

2. The method according to claim 1, wherein the copper slag comprises the following components with a mass percentage: CaO 3-10%, Al₂O₃ 3-7%, MgO 1-8%, Fe₂O₃ 5-16%, SiO₂ 32-45% and K₂O 2-4.5%.

3. The method according to claim 1, wherein the fly ash comprises the following components with a mass percentage: CaO 0.3-12.8%, Al₂O₃ 17-27%, MgO 0.1-2.9%, Fe₂O₃ 5-13%, SiO₂ 45-55% and K₂O 1-3.6%.

4. The method according to claim 1, wherein the mass of the copper slag is 10-40% of the total mass of the copper slag and the fly ash.

5. The method according to claim 4, wherein the copper slag comprises the following components with a mass percentage: CaO 3-10%, Al₂O₃ 3-7%, MgO 1-8%, Fe₂O₃ 5-16%, SiO₂ 32-45% and K₂O 2-4.5%.

6. The method according to claim 4, wherein the fly ash comprises the following components with a mass percentage: CaO 0.3-12.8%, Al₂O₃ 17-27%, MgO 0.1-2.9%, Fe₂O₃ 5-13%, SiO₂ 45-55% and K₂O 1-3.6%.

7. The method according to claim 1, wherein the alkali activator solution comprises alkali activator and water, the alkali activator comprises water glass and sodium hydroxide.

8. The method according to claim 1, wherein the mass of the alkali activator in the solution is 20-35% of the total mass of the copper slag and the fly ash.

9. The method according to claim 8, wherein the copper slag comprises the following components with a mass percentage: CaO 3-10%, Al₂O₃ 3-7%, MgO 1-8%, Fe₂O₃ 5-16%, SiO₂ 32-45% and K₂O 2-4.5%.

10. The method according to claim 8, wherein the fly ash comprises the following components with a mass percentage: CaO 0.3-12.8%, Al₂O₃ 17-27%, MgO 0.1-2.9%, Fe₂O₃ 5-13%, SiO₂ 45-55% and K₂O 1-3.6%.

11. The method according to claim 8, wherein the alkali activator solution comprises alkali activator and water, the alkali activator comprises water glass and sodium hydroxide.

12. The method according to claim 1, wherein the modulus of the alkali activator is 0.4-1.2.

13. The method according to claim 12, wherein the alkali activator solution comprises alkali activator and water, the alkali activator comprises water glass and sodium hydroxide.

14. The method according to claim 1, wherein the polymerization is performed under the condition of: temperature: 40-120° C., time: 4-24 h.

15. A copper slag-fly ash geopolymer prepared by the method according to claim 1, comprising a Si—O—Al three-dimensional net structure that the [SiO₄] tetrahedron and [AlO₄] tetrahedron are alternately bonded and polymerized through shared oxygen atoms, the chemical composition of the Si—O—Al three-dimensional net structure is Mₙ[—(SiO₂)_{z}—AlO₂]ₙ.wH₂O, wherein M is Na and/or K⁺, z [symbol] 1, w is 0-4.

16. A use of the copper slag-fly ash geopolymer according to claim 15, wherein the geopolymer can be used in civil engineering, and as the matrix of quick repair material, high temperature resistance and fire-proof material, toxic waste solid sealing material, porous insulation material or composite functional material.
